(19) United States
(12) Patent Application Publication
(10) Pub. No.: US 2010/0316338 A1
(43) Pub. Date: Dec. 16, 2010

(54) OPTICAL COMMUNICATION MODULE AND METHOD OF MANUFACTURING THE SAME

(75) Inventor: Atsushi SHONO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki-shi (JP)

(21) Appl. No.: 12/769,347

(22) Filed: Apr. 28, 2010

(30) Foreign Application Priority Data
Jun. 16, 2009 (JP) 2009-142947

(51) Int. Cl. G02B 6/36; B32B 37/12

(52) U.S. Cl. 385/93; 156/327

(57) ABSTRACT

An optical communication module includes a CAN member including a conductive stem member where an optical electronic device is mounted and a conducive lens cap that holds an optical lens optically coupled with the optical electronic device, is connected to the stem member in a conductive state, and covers a surrounding portion of the optical electronic device; a conductive cylindrical holder which is disposed around the lens cap, is fixed to the CAN member in an insulation state through an insulating resin, and is provided with an opening facing the optical lens; and an optical receptacle including an optical member that is optically coupled with the optical lens and the optical electronic device through the opening and a holding frame that holds the optical member inside.

This application is based on Japanese patent application No. 2009-142947, the content of which is incorporated hereinto by reference.

### BACKGROUND

1. Technical Field

The present invention relates to an optical communication module and a method of manufacturing the optical communication module.

2. Related Art

An optical communication module has an optical electronic device, which has a function of converting an optical signal into an electric signal or converting the electric signal into the optical signal, on a stem (for example, Japanese Patent Application Laid-open (JP-A) Nos. 2008-177310, 2007-133225, 2008-096588, and 2008-116861). The optical communication module is called an optical sub assembly (OSA), and has an optical receptacle that optically couples an external optical fiber cable and the optical electronic device.

In an apparatus that mounts the OSA, for example, a transceiver, a noise signal that is generated from a host device is transmitted to the OSA through a case ground of the transceiver. In the OSA, when the case ground and a signal ground are common, a signal is deteriorated due to a noise or a circuit is failed due to electrostatic discharge (ESD). For this reason, in the OSA, the case ground and the signal ground need to be isolated from each other.

The OSA is required to have a superior radiation characteristic.

For this reason, an optical communication module that has an electromagnetic shielding property and a radiation property as a noise countermeasure is required.

For example, in JP-A No. 2008-177310, an optical module and an optical transceiver mounting the optical module are disclosed. According to a technique that is disclosed in JP-A No. 2008-177310, an annular insulating portion is interposed between a central portion and an edge portion of the stem to insulate the signal ground and the case ground of the optical module from each other. The central portion and the edge portion of the stem are formed of a metal material, but are insulated from each other by the insulating portion. An optical device is disposed on the central portion of the stem and the central portion is the signal ground. Meanwhile, a metallic lens cap is fixed to the edge portion of the stem. The lens cap is electrically connected to a metallic optical receptacle, which is connected to a casing ground. That is, the optical receptacle is connected to the casing ground and is insulated from the signal ground. For this reason, according to the technique that is disclosed in JP-A No. 2008-177310, the optical device on the stem can be electrically shielded from the outside.

According to the technique that is disclosed in JP-A No. 2008-177310, the insulating portion is interposed between the central portion and the edge portion of the stem. However, since an insulating material generally has low thermal conductivity, the radiation property of the heat that is generated on the central portion of the stem is lowered.

As such, it has been difficult to obtain the electromagnetic shielding property without lowering the radiation property of the optical communication module.

### SUMMARY

In one embodiment, there is provided an optical communication module comprising a CAN member including a conductive stem member where an optical electronic device is mounted and a conducive lens cap that holds an optical lens optically coupled with the optical electronic device, is connected to the stem member in a conductive state, and covers a surrounding portion of the optical electronic device; a conductive cylindrical holder which is disposed around the lens cap, is fixed to the CAN member in an insulation state through an insulating resin, and is provided with an opening facing the optical lens; and an optical receptacle including an optical member that is optically coupled with the optical lens and the optical electronic device through the opening and a holding frame that holds the optical member inside.

By the optical communication module, the conductive lens cap covers the surrounding portion of the optical electronic device on the stem member, and the conductive cylindrical holder is disposed around the lens cap and is fixed to the CAN member in an insulation state through an insulating resin. For this reason, the optical electronic device that is mounted on the stem member of the CAN member may be electromagnetically shielded from the outside of the cylindrical holder by the cylindrical holder.

Since the stem member is formed of a conductive material generally having superior thermal conductivity, a radiation characteristic of heat generated on the stem member becomes superior, as compared with the case where an insulating portion is interposed between a central portion and an edge portion of the stem member.

As a result, the electromagnetic shielding property can be obtained without lowering the radiation property of the optical communication module.

In another embodiment, there is provided a method of manufacturing the optical communication module comprising fixing the cylindrical holder to the CAN member in an insulation state through the insulating resin.

According to the invention, the electromagnetic shielding property can be obtained without lowering the radiation property of the optical communication module.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a front cross-sectional view illustrating an optical communication module according to a first embodiment;

FIGS. 2A to 2C are process views illustrating a method of manufacturing the optical communication module according to the first embodiment;

FIG. 3 is a diagram illustrating a temperature distribution and a structure of a main portion of an optical communication module according to a comparative example;

FIG. 4 is a diagram illustrating a temperature distribution and a structure of a main portion of the optical communication module according to the first embodiment; and

FIG. 5 is a front cross-sectional view illustrating an optical communication module according to a second embodiment.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained below, referring to the attached drawings. Note that any similar constituents will be given the same reference numerals or symbols in all drawings, and explanations therefor will not be repeated.

### First Embodiment

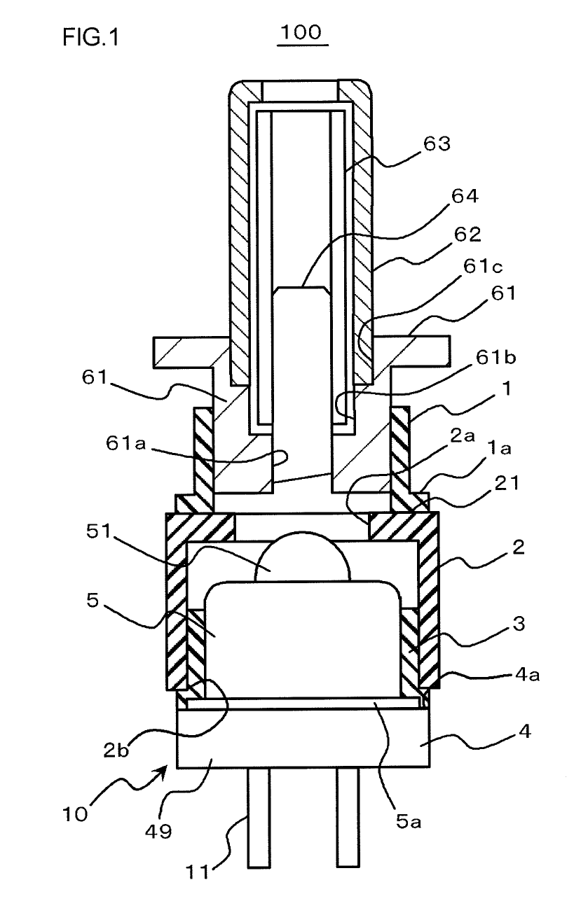

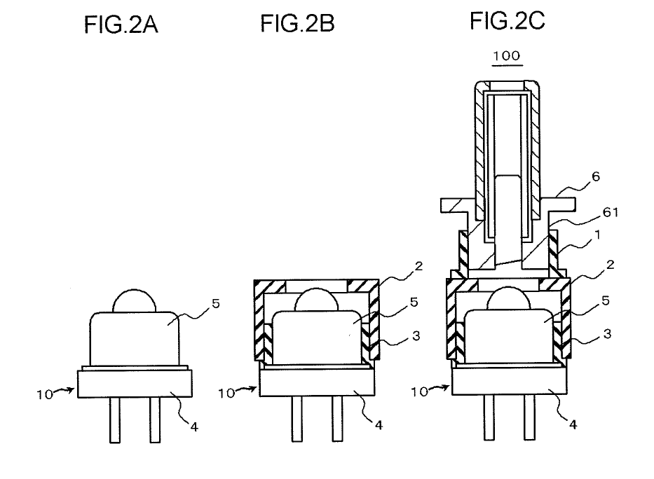

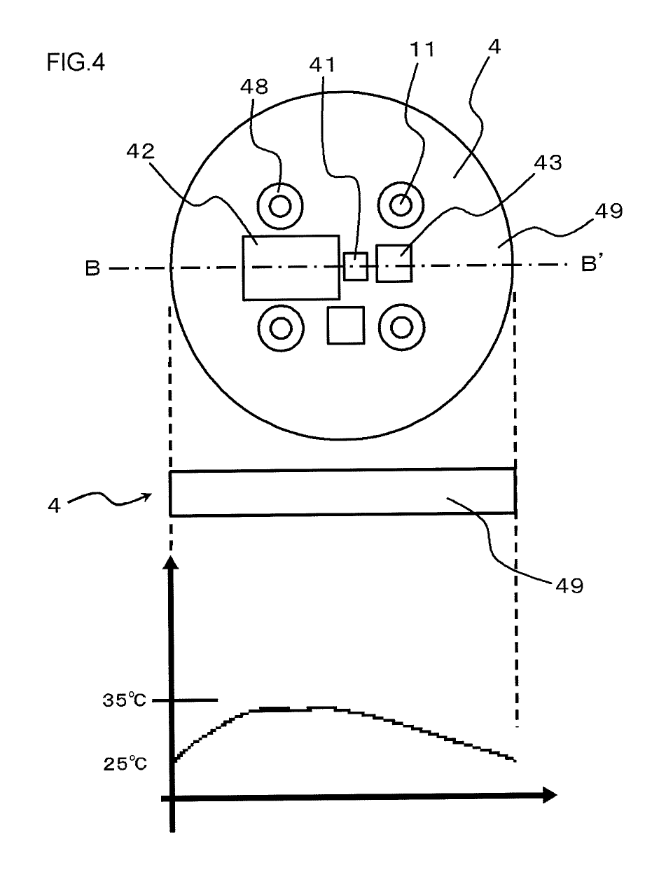

FIG. 1 is a front cross-sectional view illustrating an optical communication module 100 according to a first embodiment and FIGS. 2A to 2C are process views illustrating a method of manufacturing the optical communication module according to the first embodiment. FIG. 4 is a diagram illustrating a temperature distribution and a structure of a main portion of the optical communication module 100 according to the first embodiment. Specifically, FIG. 4 illustrates a plane of a top surface of a stem member 4 and components on the stem member 4 in an upper part, illustrates a section of the stem member 4 taken along the line B-B′ in a middle part, and illustrates a temperature distribution along the line B-B′ in a lower part.

The optical communication module 100 according to the first embodiment has a CAN member 10, a cylindrical holder 2, and an optical receptacle 6. The CAN member 10 includes a conductive stem member 4 and a conductive lens cap 5. On the stem member 4, an optical electronic device (for example, light receiving element 41 (refer to FIG. 4) is mounted. The lens cap 5 holds an optical lens 51 that is optically coupled with the optical electronic device. The lens cap 5 is connected to the stem member 4 to become a conductive state and covers a surrounding portion of the optical electronic device. The cylindrical holder 2 has conductivity and is disposed around the lens cap 5. The cylindrical holder 2 is fixed to the CAN member 10 in an insulation state through an insulating resin 3. In the cylindrical holder 2, an opening 2a that faces the optical lens 51 is formed. The optical receptacle 6 includes an optical member (for example, stub ferrule 64) and a holding frame (for example, holder 61) that holds the optical member inside. The optical member is optically coupled with the optical lens 51 and the optical electronic device through the opening 2a of the cylindrical holder 2.

The optical communication module 100 further has a conductive sleeve (Z-axis sleeve 1) that is interposed between the holding frame and the cylindrical holder 2 and fixes the holding frame and the cylindrical holder 2 to each other.

Each of a base (to be described below) of the stem member 4, the lens cap 5, the optical receptacle 6, the cylindrical holder 2, and the Z-axis sleeve 1 is formed of a metal, which will be described in detail below.

The stem member 4 has a conductive base 49 that is formed in a disc shape. On one surface of the base 49, as illustrated in FIG. 4, electronic devices, such as the light receiving element 41, a preamplifier IC (Integrated Circuit) 42, and a capacitor 43, are mounted. In the stem member 4, plural leads 11 are provided. As illustrated in FIG. 1, the leads 11 penetrate the stem member 4 and protrude from the other surface of the stem member 4. Around the leads 11, insulating portions 48 that insulate the leads 11 and the base 49 from each other are formed.

The lens cap 5 is formed in a cylindrical shape and holds the optical lens 51 in an opening of one end side thereof. In the lens cap 5, an end of an opening of the other end side is a flange portion 5a that is formed in a flange shape. The flange portion 5a is fixed to one surface of the stem member 4 through welding. As a result, the lens cap 5 seals the each electronic devices on the stem member 4 inside.

A diameter of the flange portion 5a is set to be smaller than a diameter of the stem member 4, and an edge portion 4a of one surface of the stem member 4 is positioned at the outside of the flange portion 5a.

Since the base 49 of the stem member 4 and the lens cap 5 have conductivity, the signal ground that is the potential of the base 49 and the lens cap 5 are electrically connected to each other and the base 49 and the lens cap 5 become have the same potential.

The cylindrical holder 2 is formed in a cylindrical shape where both ends are opened. For example, one opening 2a of the cylindrical holder 2 is formed to be narrower than the other opening 2b. Thereby, in an edge portion of the opening 2a, a fixation surface 21 to which a Z-axis sleeve 1 to be descried in detail below is fixed is formed.

The cylindrical holder 2 is connected to the CAN member 10 through the insulating resin 3. For this reason, the cylindrical holder 2 and the CAN member 10 are insulated from each other.

Specifically, the insulating resin 3 is continuously formed over an interval between inner circumference of the cylindrical holder 2 and a surrounding portion of a cylindrical portion of the lens cap 5, an interval between an end face (lower end face of FIG. 1) of the cylindrical holder 2 and the flange portion 5a, and an interval between the end face (lower end face of FIG. 1) of the cylindrical holder 2 and the edge portion 4a of the stem member 4. As a result, the insulating resin 3 is interposed between the cylindrical holder 2 and the CAN member 10, and a contact state between the cylindrical holder 2 and the CAN member 10 is appropriately suppressed.

As the insulating resin 3, for example, a UV hardened or a thermally hardened material is used. The insulating resin 3 is preferably a material where a temporal variation is small and connection strength when metals are connected to each other is strong.

The cylindrical holder 2 is disposed to cover almost entire portions of the lens cap 5.

The optical receptacle 6 includes a holder 61, a shell 62, a sleeve 63, and a stub ferrule 64 functioning as an optical member. The holder 61 is formed in a cylindrical shape. At inner circumference of the holder 61, a first holding portion 61a where one end of the stub ferrule 64 is fitted and the stub ferrule 64 is held, an accommodation portion 61b that accommodates one end of the sleeve 63, and a second holding portion 61c where one end of the shell 62 is fitted and the shell 62 is held are sequentially formed. The other end of the stub ferrule 64 is fitted into one end of the cylindrical sleeve 63. Thereby, the holder 61 also holds the sleeve 63 through the stub ferrule 64. The sleeve 63 is disposed from an inner portion of the accommodation portion 61b of the holder 61 to an inner portion of the shell 62. The shell 62 is formed in a cylindrical shape and is configured to insert an optical connector (not illustrated) from a front end side thereof. The holder 61 and the shell 62 are formed of a conductive material (for example, metal). The sleeve 63 may be formed of a conductive material (for example, metal) or an insulating material.

The Z-axis sleeve 1 is formed in a cylindrical shape and its one end becomes a flange portion 1a that has a flange shape. The flange portion 1a is fixed to the fixation surface 21 of the cylindrical holder 2 by spot welding. A portion of the holder 61 of the optical receptacle 6 is fitted into the inner circumference of the Z-axis sleeve 1. The inner circumference of the Z-axis sleeve 1 and the portion of the holder 61 are fixed by the spot welding. That is, the Z-axis sleeve 1 is spot welded to the holder 61 and the cylindrical holder 2 and fixes the holder 61 and the cylindrical holder 2 to each other. As the spot welding, YAG welding may be applied.

In the stub ferrule 64, an optical fiber (not illustrated) is provided. The optical fiber is optically coupled with the optical lens 51 through the opening 2a of the cylindrical holder 2 and is optically coupled with the light receiving element 41 in the CAN member 10 through the optical lens 51.

In a hollow portion in the sleeve 63, a plug ferrule of an optical connector (not illustrated) is inserted into a portion where the stub ferrule 64 is not disposed. In the plug ferrule, an optical fiber is provided. When the plug ferrule is inserted into the sleeve 63 and a front end face of the plug ferrule is made to bump against a front end face of the stub ferrule 64, the optical fiber of the stub ferrule 64 and the optical fiber of the plug ferrule are optically coupled with each other.

In this case, each of the cylindrical holder 2, the Z-axis sleeve 1, the holder 61, and the shell 62 is formed of a metal, and the Z-axis sleeve 1 is spot welded to the cylindrical holder 2 and the holder 61. As a result, the cylindrical holder 2, the Z-axis sleeve 1, the holder 61, and the shell 62 are electrically connected to each other.

Next, a method of manufacturing an optical communication module according to the first embodiment will be described. The method of manufacturing an optical communication module that is a method of manufacturing the optical communication module 100 according to the first embodiment, and includes a process of fixing the cylindrical holder 2 to the CAN member 10 in an insulation state through the insulating resin 3, which will be described in detail below.

First, the electronic devices, such as the light receiving element 41, the preamplifier IC 42, and the capacitor 43, are mounted on the stem member 4. Next, the lens cap 5 is fixed on the stem member 4, the individual electronic devices on the stem member 4 are sealed, and the CAN member 10 is formed (refer to FIG. 2A).

Next, the cylindrical holder 2 is connected to the CAN member 10 in an insulation state through the insulating resin 3 (refer to FIG. 2B).

Next, the holder 61 of the optical receptacle 6 that is previously assembled is connected to the cylindrical holder 2 through the Z-axis sleeve 1. That is, the Z-axis sleeve 1 is spot welded to the holder 61 and the cylindrical holder 2 and the holder 61 and the cylindrical holder 2 are fixed to each other (refer to FIG. 2C).

In this way, the optical communication module 100 can be manufactured.

As such, according to the first embodiment, the conductive lens cap 5 covers the surrounding portions of the electronic devices, such as the light receiving element 41 and the preamplifier IC 42, which are mounted on the stem member 4. The conductive cylindrical holder 2 is disposed around the lens cap 5 and is fixed to the CAN member 10 in an insulation state through the insulating resin 3. For this reason, the electronic devices, such as the light receiving element 41 and the preamplifier IC 42, which are mounted on the stem member 4 of the CAN member 10, can be electromagnetically shielded from the outside of the cylindrical holder 2, by the cylindrical holder 2. Therefore, the electronic devices can be securely protected from the noises generated around the cylindrical holder 2.

Since the stem member 4 is formed of a conductive material having superior thermal conductivity, a radiation characteristic of the heat that is generated from the electronic devices on the stem member 4 becomes superior, as compared with the case where the insulating portion is interposed between the central portion and the edge portion of the stem member 4.

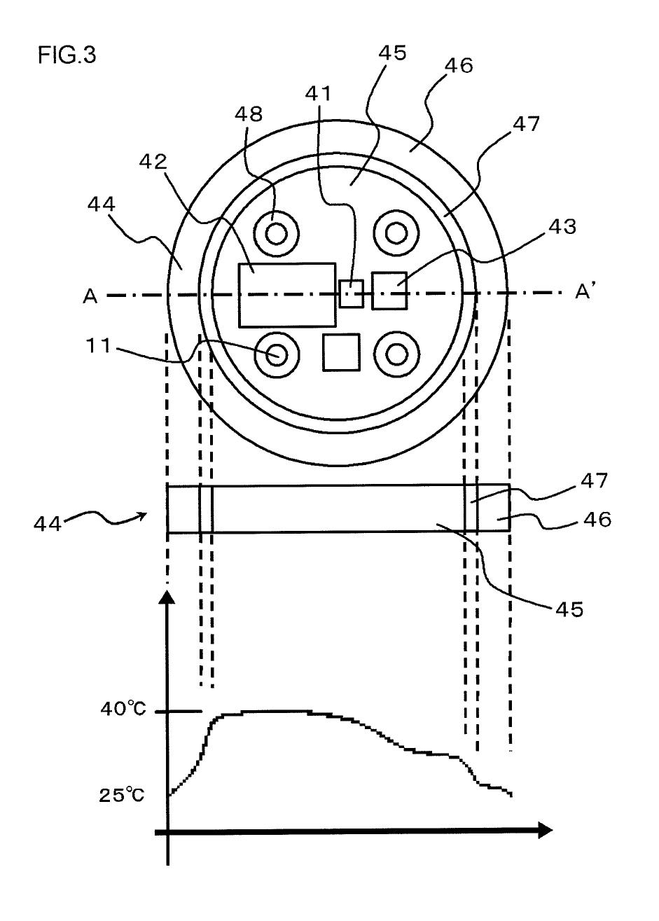

FIG. 3 is a diagram illustrating a temperature distribution and a structure of a main portion of an optical communication module according to a comparative example. Specifically, FIG. 3 illustrates a plane of a top surface of a stem member 44 and components on the stem member 44 in an upper part, illustrates a section of the stem member 44 taken along the line A-A′ in a middle part, and illustrates a temperature distribution along the line A-A′ in a lower part. The optical communication module according to the comparative example has the same configuration as that of the optical communication module 100 according to the first embodiment, except that an insulating portion 47 is formed in the stem member 44. That is, as illustrated in FIG. 3, the stem member 44 includes a central portion 45 where the electronic devices, such as the light receiving element 41, the preamplifier IC 42, and the capacitor 43, are mounted, an edge portion 46, and an annular insulating portion 47 that is interposed between the central portion 45 and the edge portion 46. Accordingly, the central portion 45 and the edge portion 46 of the stem member 44 are electrically insulated from each other through the insulating portion 47. The insulating portion 47 is glass-sealed.

In FIGS. 3 and 4, the lower parts illustrate temperate measurement results in the stem members 44 and 4, respectively.

In FIG. 3, the temperature of an end of the stem member 44 is 25° C. Since the radiation characteristic in the glass-sealed insulating portion 47 is deteriorated, the peripheral temperature of the preamplifier IC 42 increases to about 40° C., due to generation of the heat from the preamplifier IC 42.

Meanwhile, in the optical communication module 100 according to the first embodiment, as illustrated in FIG. 4, since an insulating portion that has a concentric circle shape equal to the shape of the stem member 4 does not exist in the stem member 4, the heat diffuses through the stem member 4, and the temperature of the preamplifier IC 42 is maintained at the temperature less than or equal to 35° C. In these experiments, the temperatures of the ends of the stem members 4 and 44 are set to 25° C. However, as the ambient temperature increases, the amount of heat generation of the preamplifier IC 42 increases. As a result, a temperature difference in the comparative example and the first embodiment increases.

As such, according to the first embodiment, the electromagnetic shielding property can be obtained without lowering the radiation property of the optical communication module 100.

In the structure of FIG. 3 or in the structure that is disclosed in JP-A No. 2008-177310, since the insulating portion exists in the stem member, an area where the electronic devices can be mounted is narrow. In particular, if the structure is applied to an optical reception sub assembly (ROSA), the number of electronic devices to be mountable is restricted.

Meanwhile, in the first embodiment, since an insulating portion that has a concentric circle shape equal to the shape of the stem member 4 does not exist in the stem member 4, the number of mounted electronic devices is not restricted.

According to the technique that is disclosed in JP-A No. 2008-116861, the receptacle and the CAN member are connected using the UV hardened resin. In this connection method, an optical coupling deviation is generated due to cure shrinkage at the time of fixation using the resin. In general, since a cure shrinkage ratio of the UV hardened resin is several % to 10%, the amount of optical coupling deviation due to the cure shrinkage becomes several μm to 10 μm. For example, as in a PIN-PD for 2.5 G communication, when a light reception diameter is large as 50 μm and an influence of a characteristic variation due to the optical coupling deviation is small, a problem is not generated. However, as in an APD element for 10 G communication, when a light reception diameter is small as about 20 μm, the characteristic variation due to the optical coupling deviation is large, and a method that uses the resin when the receptacle and the CAN member are connected to each other is not preferable. As in an LD module, even when the coupling deviation of about several μm is affected by an optical output, this method is not preferable.

Meanwhile, in the first embodiment, since the optical receptacle 6 and the cylindrical holder 2 are spot welded and fixed to each other through the Z-axis sleeve 1, the optical receptacle 6, the cylindrical holder 2, and the Z-axis sleeve 1 can be simply assembled with high precision in a conductive state. In general, connection precision of the spot welding is 1 μm or less. For this reason, the optical receptacle 6 can be fixed to the cylindrical holder 2 with high precision, and the stub ferrule 64 of the optical receptacle 6 can be optically coupled with the optical lens 51 and the light receiving element 41 with high precision. The optical communication speed is from MHz order to GHz order, and optical communication of the communication speed of 10 Gb/s is commercially used in recent years. When the OSA is a PD module that has the light receiving element 41, a light reception diameter of the light receiving element 41 is 50 to 80 pmp in the past. However, in recent years, in order to realize an increase in speed, the light reception diameter decreases to 20 to 30 μmφ. With respect to the light receiving element 41 having the small light reception diameter, the optical receptacle 6 can be optically coupled with high precision.

When the optical communication module 100 is mounted on an optical transmission device, the cylindrical holder 2 can be connected to the case ground and the stem member 4 can be connected to the signal ground. That is, the signal ground and the case ground can be electrically insulated from each other.

Since the conductive cylindrical holder 2 is connected to the CAN member 10 through the insulating resin 3 to cover the conductive lens cap 5, an external electromagnetic noise can be released to the case ground. That is, the external electromagnetic noise can be shielded by the cylindrical holder 2.

In recent years, with a size decrease of an apparatus that mounts the OSA, the optical communication module is also required to have a small size.

In the structure that is disclosed in JP-A No. 2007-133225, the case ground and the signal ground are isolated from each other by extending the stub ferrule. That is, the receptacle module that is disclosed in JP-A No. 2007-133225 has a first holder and a second holder that is disposed away from the first holder and is insulated from the first holder. The first and second holders are structurally connected to each other through the insulating stub ferrule. The insulation of the first and second holders is realized by increasing the length of the stub ferrule in an optical axis direction by the amount corresponding to a distance between the first and second holders. For this reason, according to the technique that is disclosed in JP-A No. 2007-133225, the size of the receptacle increases by the amount where the stub ferrule is extended.

In the structure that is disclosed in JP-A No. 2007-133225, a metal portion of the CAN member (stem member and cap) side of the receptacle and the CAN member are connected to the signal ground, only the front end side of the receptacle is electrically insulated, and the CAN member is connected to the signal ground. For this reason, in the structure that is disclosed in JP-A No. 2007-133225, it is difficult to electromagnetically shield the CAN member from the surrounding portion with effective.

Likewise, in the structure that is disclosed in JP-A No. 2008-096588, the receptacle is connected to the CAN member (device unit) through an insulating unit having an insulating member. The insulating unit and the receptacle are connected to each other by brazing or sealing, and the insulating unit and the CAN member are also connected to each other by brazing or sealing. In the technique that is disclosed in JP-A No. 2008-096588, since only the front end side of the receptacle is electrically insulated, it is difficult to electromagnetically shield the CAN member from the surrounding portion with effective.

Meanwhile, in the first embodiment, since the CAN member 10 and the cylindrical holder 2 are insulated from each other, the length of the receptacle does not need to be increased, the size of the OSA can be easily decreased, and the CAN member 10 can be electromagnetically shielded from the surrounding portion with effective.

### Second Embodiment

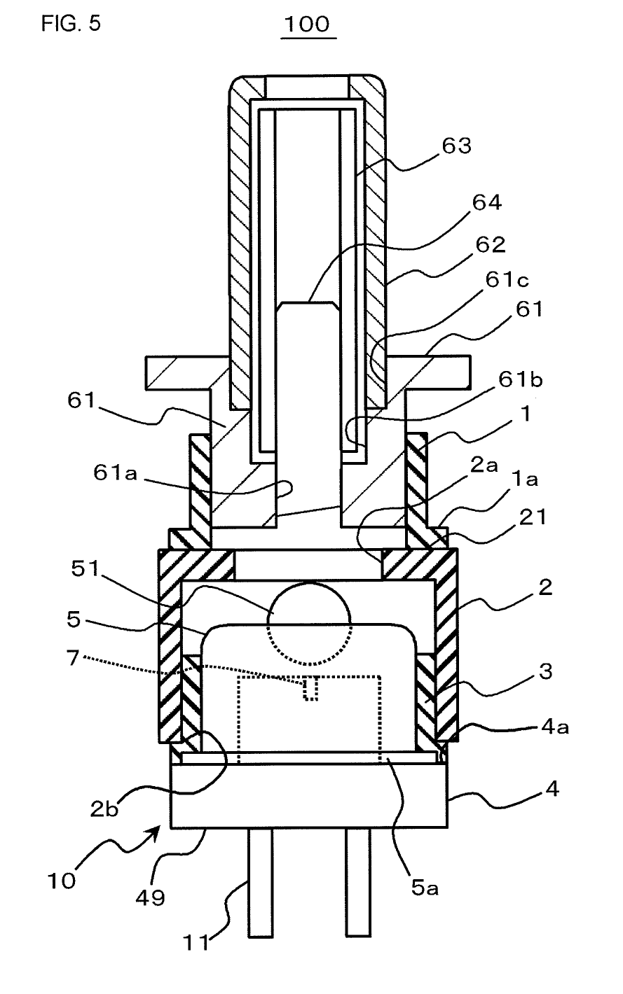

FIG. 5 is a front cross-sectional view illustrating an optical communication module 200 according to a second embodiment.

The optical communication module 200 according to the second embodiment is a transmission-side OSA (TOSA). The optical communication module 200 according to the second embodiment has, on the stem member 4, a light emitting element (LD; Laser Diode) 7 and a driver IC (not illustrated) of the light emitting element 7, instead of the light receiving element 41 (refer to FIG. 1) and the preamplifier IC 42. Except for this configuration, the configuration of the optical communication module 200 is the same as the configuration of the optical communication module 100 according to the first embodiment.

In the second embodiment, the electromagnetic noise that is generated from the light emitting element 7 functioning as the optical electronic device and the driver IC thereof can be absorbed by the Z-axis sleeve 1, the cylindrical holder 2, and the optical receptacle 6 connected to the case ground.

Accordingly, in an actual transceiver, the amount of noise that is propagated to an optical reception sub assembly (ROSA) mounted on a flank of an LD module (TOSA) can be decreased, and the TOSA and the ROSA can realize superior characteristics.

In the structure of FIG. 3 or in the structure that is disclosed in JP-A No. 2008-177310, since the insulating portion exists in the stem member, the radiation characteristic is bad. In particular, if the technique is used in an optical transmission sub assembly (TOSA), a size of a radiation portion is restricted, and the radiation characteristic of the light emitting element cannot be sufficiently obtained.

Meanwhile, in the second embodiment, since an insulating portion that has a concentric circle shape equal to the shape of the stem member 4 does not exist in the stem member 4, the above problem is not generated.

In the structure that is disclosed in JP-A No. 2007-133225, as descried above, the case ground and the signal ground are isolated from each other by extending the stub ferrule. Therefore, the size of the receptacle increases.

In the structure that is disclosed in JP-A No. 2007-133225, as described above, it is difficult to electromagnetically shield the CAN member from the surrounding portion with effective. For this reason, it is difficult to effectively shield a radiation noise generated from the transmission side (TOSA side) in a small transceiver, such as SFP+(Small Form Factor Pluggable+) or XFP (10 Gigabit Small Form Factor Pluggable) that is the industry standard of a removable module of 10 Gb/s.

Even in the structure that is disclosed in JP-A No. 2008-096588, it is difficult to effectively shield the radiation noise, similar to the structure that is disclosed in JP-A No. 2007-133225.

Meanwhile, in the second embodiment, since the CAN member 10 and the cylindrical holder 2 are insulated from each other, the length of the receptacle does not need to be increased, the size of the OSA can be easily decreased, and the CAN member 10 can be electromagnetically shielded from the surrounding portion.

According to the second embodiment, the same effect as that of the first embodiment can be obtained.

In the second embodiment, the optical communication module 200 may not have the driver IC for the light emitting element 7. Even in this case, since an insulating portion that has a concentric circle shape equal to the shape of the stem member 4 do not exist in the stem member 4, the radiation characteristic of the heat generation from the light emitting element 7 becomes superior.

It is apparent that the present invention is not limited to the above embodiments, and may be modified and changed without departing from the scope and spirit of the invention.

What is claimed is:

1. An optical communication module, comprising:
a CAN member including a conductive stem member where an optical electronic device is mounted and a conductive lens cap that holds an optical lens optically coupled with said optical electronic device, is connected to said stem member in a conductive state, and covers a surrounding portion of said optical electronic device;
a conductive cylindrical holder which is disposed around said lens cap, is fixed to said CAN member in an insulation state through an insulating resin, and is provided with an opening facing said optical lens; and
an optical receptacle including an optical member that is optically coupled with said optical lens and said optical electronic device through said opening and a holding frame that holds said optical member inside.

2. The optical communication module according to claim 1, further comprising:
a conductive sleeve which is interposed between said holding frame and said cylindrical holder and fixes said holding frame and said cylindrical holder to each other.

3. The optical communication module according to claim 2, wherein said holding frame has conductivity.

4. The optical communication module according to claim 3,
wherein each of said cylindrical holder, said sleeve, and said holding frame is formed of a metal, and
said sleeve is spot welded to each of said holding frame and said cylindrical holder and fixes said holding frame and said cylindrical holder to each other.

5. The optical communication module according to claim 1,
wherein said optical electronic device is a light receiving element.

6. The optical communication module according to claim 1,
wherein said optical electronic device is a light emitting element.

7. A method of manufacturing the optical communication module according to claim 1, the method comprising:
fixing said cylindrical holder to said CAN member in an insulation state through said insulating resin.
